(19) United States
(12) Patent Application Publication
(10) Pub. No.: US 2019/0094987 A1
(43) Pub. Date: Mar. 28, 2019

(54) IMAGE PROCESSING APPARATUS, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: Hikaru Sugita, Toride-shi (JP)

(21) Appl. No.: 16/133,366

(22) Filed: Sep. 17, 2018

(30) Foreign Application Priority Data
Sep. 27, 2017 (JP) 2017-187133

(51) Int. Cl. G06F 3/023; G06F 3/041; G06F 3/0482; H04N 1/00

(52) U.S. Cl. CPC G06F 3/0233; H04N 1/00214; G06F 3/0482; G06F 3/0412

(57) ABSTRACT

If an image processing apparatus converts a character code of a character whose input is received from an external information processing apparatus into a character code preset in the apparatus, the image processing apparatus may be unable to correctly convert the character. Various embodiments of the present disclosure provide a method for controlling an image processing apparatus including transmitting an electronic mail containing a character input from an external information processing apparatus via a web browser. The method includes receiving a character code, and converting a character code of the character contained in the electronic mail. The converting includes converting the character code of the character input from the external information processing apparatus into the character code received by the receiving. The transmitting includes transmitting the electronic mail containing the character represented by the character code converted by the converting.

### BACKGROUND

### Field

The present disclosure relates to an image processing apparatus, a method for controlling an image processing apparatus, and a storage medium capable of setting a character code of a character contained in an electronic mail.

### Description of the Related Art

An image processing apparatus (especially, a multifunction peripheral (MFP)) transmits a subject and a message body as an electronic mail. A character written in the subject/message body is formed by a character code. Since the image processing apparatus is used in various countries, various kinds of character codes are also used for the character written in the subject/message body of the electronic mail.

Japanese Patent Application Laid-Open No. 2007-116323 discusses that, when transmitting an electronic mail, an image processing apparatus detects a destination from an area name of a transmission destination, and detects a possibility that an apparatus on a reception side does not support a character string represented by a non-American Standard Code for information Interchange (ASCII) code. Then, if there is a character string that does not correspond to the non-ASCII code, the image processing apparatus deletes the non-ASCII code because a garbled character is generated when the character code is converted.

The image processing apparatus can receive an input of the subject/message body of the electronic mail from an external information processing apparatus (for example, a personal computer (PC)). If the subject and the message body of the electronic mail are input from an external information processing terminal, the input character is represented by a character code set in the external information processing terminal. For example, if the character is input to the electronic mail on the image processing apparatus via a web browser with use of a PC on which French is set as a character setting, the character input to the image processing apparatus is not represented by a character code for Japanese but is represented by a character code for French.

In such a configuration, the image processing apparatus may be unable to correctly convert the character code for some character if the image processing apparatus converts the character code of the character whose input is received from the external information processing apparatus into a character code preset in the apparatus. Then, when an electronic mail containing such a character is transmitted, the garbled character such as a blank may be generated on the transmission destination.

### SUMMARY

According to an aspect of the present disclosure, an image processing apparatus includes a transmission unit configured to transmit an electronic mail containing a character input from an external information processing apparatus via a web browser. The image processing apparatus includes a reception unit configured to receive a character code, and a conversion unit configured to convert a character code of the character contained in the electronic mail. The conversion unit converts the character code of the character input from the external information processing apparatus into the character code received by the reception unit. The transmission unit transmits the electronic mail containing the character represented by the character code converted by the conversion unit.

Further features of the present disclosure will become apparent from the following description of exemplary embodiments with reference to the attached drawings.

### BRIEF DESCRIPTION OF THE DRAWINGS

FIG. 1 is a block diagram illustrating a network structure according to one embodiment.

FIG. 2 is a block diagram illustrating a configuration of a multifunction peripheral (MFP) according to one embodiment.

FIG. 3 illustrates a layout of an operation panel and a HOME screen displayed on a touch pane according to one embodiment 1.

FIGS. 4A, 4B, and 4C illustrate character code setting screens displayed on the touch panel according to one embodiment.

FIGS. 5A and 5B illustrate character code conversion processing according to one embodiment.

FIG. 6 illustrates a screen for setting a subject/message body of an electronic mail, which is displayed on the touch pane according to one embodiment 1.

FIG. 7 is a flowchart regarding electronic mail transmission processing according to one embodiment.

FIG. 8 is a flowchart regarding electronic mail transmission processing according to one embodiment.

### DESCRIPTION OF THE EMBODIMENTS

An exemplary embodiment of the present disclosure and an exemplary modification thereof will be described in detail with reference to the accompanying drawings. The exemplary embodiment that will be described below does not limit the present disclosure, and, further, not all of combinations of features that will be described in the exemplary embodiment and the exemplary modification are necessarily essential to all embodiments of the present disclosure.

An image processing apparatus according to the present exemplary embodiment allows a user to select a character code used after character code conversion processing. A central processing unit (CPU) of the image processing apparatus converts a character code of a character input by a web browser of an external information processing apparatus in such a manner that it is replaced with the character code selected by the user. Then, the image processing apparatus transmits an electronic mail containing the character represented by the converted character code.

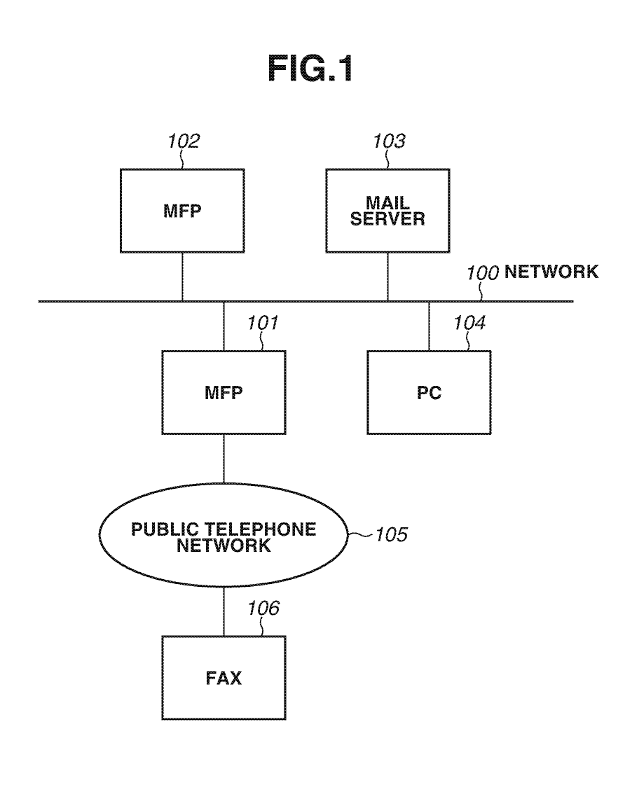

FIG. 1 is a block diagram illustrating a network configuration according to the present exemplary embodiment.

FIG. 1 illustrates an image processing apparatus (hereinafter referred to as an MFP 101) as one example of a transmission source, and an information processing apparatus (hereinafter referred to as a PC 104), an image processing apparatus (hereinafter referred to as an MFP 102), and a facsimile apparatus (hereinafter referred to as a FAX 106) as one example of a transmission destination.

In FIG. 1, the MFP 101, the MFP 102, a mail server 103, and the PC 104 are communicably connected to one another via a network 100.

Further, the MFP 101 and the FAX 106 are communicably connected to each other via a public telephone network 105.

The MFP 101 transmits an electronic mail containing scanned image data to the MFP 102 or the PC 104 via the mail server 103.

The mail server 103 stores the electronic mail received from the MFP 101 in a mail box prepared in a storage (not illustrated) as an electronic mail to be received by the MFP 102 or the PC 104.

The MFP 102 receives the electronic mail transmitted by the MFP 101 from the mail box in the mail server 103 with use of a set account for receiving the electronic mail.

The PC 104 receives the electronic mail transmitted by the MFP 101 from the mail box in the mail server 103 with use of a set account for receiving the electronic mail. Further, the PC 104 can operate the MFP 101 remotely with use of a web browser.

The FAX 106 receives a facsimile transmitted with use of a FAX number as which the FAX 106 is set, from the MFP 101.

In FIG. 1, the network 100 is illustrated as a local network. However, networks employable as an effective communication method include any kind of network, such as the Internet, and a configuration wirelessly connected to an access point (not illustrated), provided that this configuration is a network configuration capable of transmitting data.

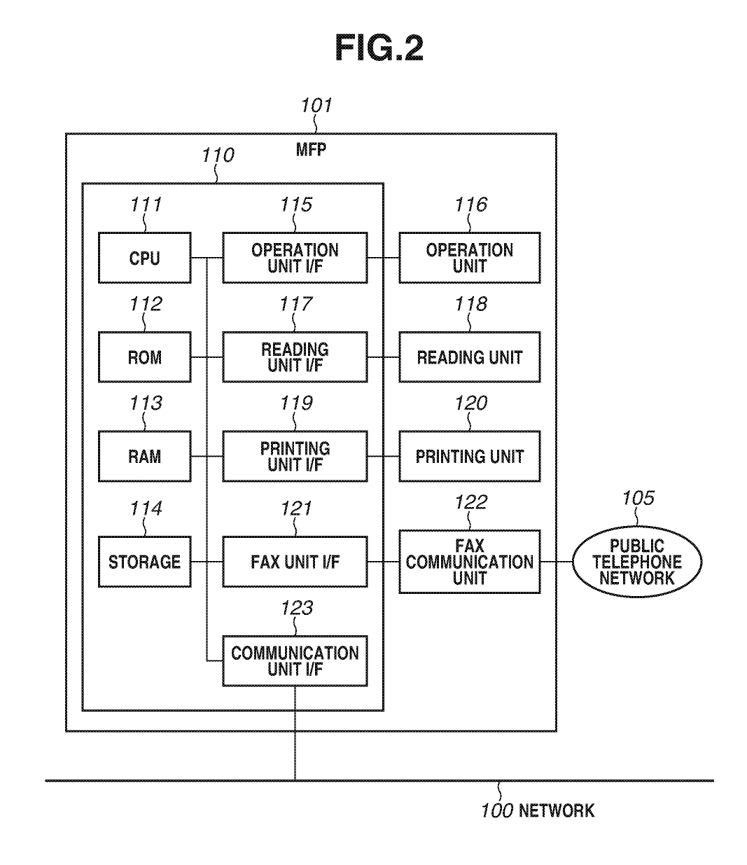

FIG. 2 is a block diagram illustrating a configuration of the MFP 101 according to the present exemplary embodiment. A control unit 110 including a CPU 111 controls an operation of the entire MFP 101. The CPU 111 reads out a control program stored in a read only memory (ROM) 112 or a storage 114, and performs various kinds of control such as conversion control and transmission control.

The ROM 112 stores a control program executable by the CPU 111 therein. Further, the ROM 112 also stores a boot program, font data, and the like therein. A random access memory (RAM) 113 is a main storage memory of the CPU 111, and is used as a work area, i.e., a temporary storage area for developing various kinds of control programs stored in the ROM 112 and the storage 114. The storage 114 stores image data, print data, various kinds of programs, and various kinds of setting information therein. In the present exemplary embodiment, the storage 114 is assumed to be embodied by a flash memory, but an auxiliary storage device such as a solid state drive (SSD), a hard disk drive (HDD), and an embedded Multi Media Card (eMMC) can be used as the storage 114.

The MFP 101 according to the present exemplary embodiment is assumed to be configured in such a manner that one CPU 111 performs each processing procedure illustrated in a flowchart that will be described below with use of one memory (the RAM 113), but is not limited to this configuration. For example, the MFP 101 can also be configured to cause a plurality of CPUs, RAMs, ROMs, and storages to cooperate with one another to perform each processing procedure illustrated in the flowchart that will be described below. Further, a part of the processing can be performed with use of a hardware circuit such as an application specific integrated circuit (ASIC) or a field programmable gate array (FPGA).

An operation unit interface (I/F) 115 connects an operation unit 116 and the control unit 110 to each other. The operation unit 116, for example, displays information to a user and detects an input from the user. The CPU 111 is notified of the detected input from the user via the operation unit I/F 115. Then, the CPU 111 performs control based on the input that the CPU 111 is notified of.

A reading unit I/F 117 connects a reading unit 118 and the control unit 110 to each other. The reading unit 118 reads an image on an original document and converts this image into image data such as binary data.

The CPU 111 performs control of transmitting the image data generated by the reading unit 118 to an external apparatus via a communication unit I/F 123. Alternatively, the CPU 111 may perform control of inputting the image data to a printing unit 120 via the reading unit I/F 117 and a printing unit I/F 119 and causing the printing unit 120 to print an image on a recording sheet based on the input image data. Further, the CPU 111 may perform control of causing the image data generated by the reading unit 118 to be stored into the storage 114 via the reading unit I/F 117.

The printing unit I/F 119 connects the printing unit 120 and the control unit 110 to each other. The CPU 111 performs control of inputting image data of a print target to the printing unit 120 via the printing unit I/F 119. The printing unit 120 prints an image on a recording sheet fed from a sheet feeding cassette.

The communication unit I/F 123 connects the control unit 110 and the network 100 to each other. The CPU 111 may perform, via the communication unit I& 123, control of causing image data and various kinds of information inside the MFP 101 to be transmitted to an external apparatus and of causing print data to be received from the external apparatus on the network 100.

Examples of a method for the transmission/reception via the network 100 include transmission/reception using the above-described electronic mail, and a method that transmits a file with use of another protocol (for example, File Transfer Protocol (FTP), Server Message Block (SMB), or Web Distributed Authoring and Versioning (WebDAV)). Further, the examples of the method for the transmission/reception via the network 100 also include a method in which the MFP 101 is equipped with a web server function and causes a received job history or various kinds of setting data to be displayed on the PC 104 in response to access from the PC 104 in compliance with the Hypertext Transfer Protocol (HTTP) protocol. However, the present exemplary embodiment is not limited to these methods.

The CPU 111 can connect the MFP 101 to the public telephone network 105 by controlling a FAX communication unit 122 by a FAX unit I/F 121. The FAX unit I/F 121 is an I/F for controlling the FAX communication unit 122. The CPU 111, for example, connects the MFP 101 to the public telephone network 105 and controls a facsimile communication protocol by controlling a modem for the facsimile communication or a network control unit (NCU) via the FAX unit I/F 121.

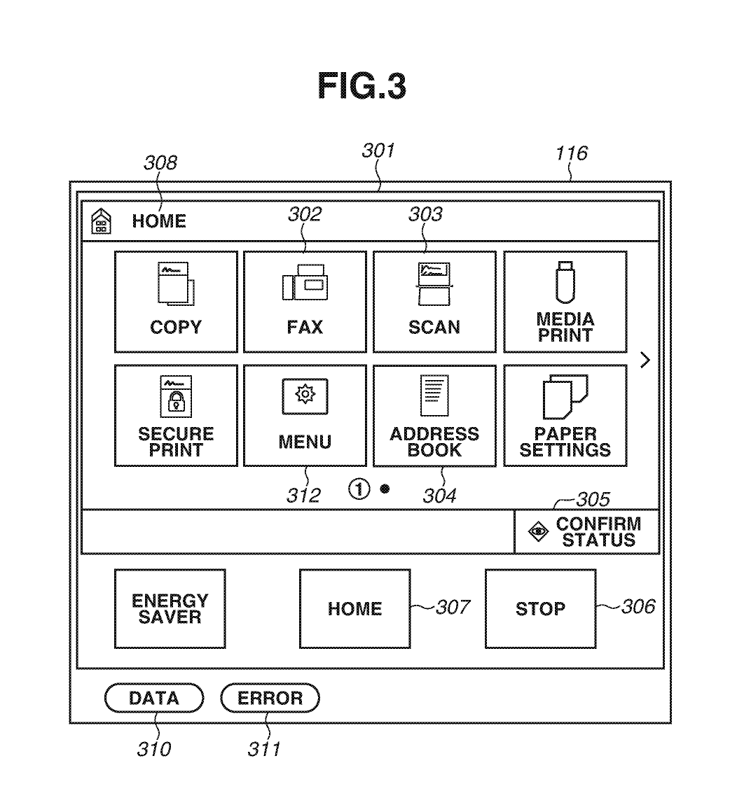

FIG. 3 illustrates a display screen on the operation unit 116. The operation unit 116 includes a touch panel 301 on which an operation screen is displayed, a light-emitting diode (LED) 310, and an LED 311. The touch panel 301 functions as a reception unit that receives an instruction from the user as a touch panel. When the user touches the screen displayed on the touch panel 301 with his/her finger or an object such as a stylus, the CPU 111 issues an instruction to fulfill each function based on the touched screen.

The operation screen illustrated in FIG. 3 indicates a HOME screen 308. The HOME screen 308 is a screen displayed first for issuing an instruction to fulfill each of functions of the MFP 101, and a screen on which the user selects a key for transitioning to a screen on which the user configures various kinds of settings of each of the functions to be fulfilled by the MFP 101, such as copying, faxing, scanning, and media printing.

A status confirmation screen 305 is a key for displaying a screen on which the user confirms a state of the MFP 101 (a status confirmation screen). The status confirmation screen allows a transmission history to be displayed.

A fax 302 is a key for displaying a facsimile transmission setting screen (not illustrated) of the MFP 101. The MFP 101 sets a destination from a telephone number, an address book, or the like from the facsimile transmission screen, and transmits the image data read by the reading unit 118 by fax (faxes the image data) to an apparatus at the other end.

A scan 303 is a key for displaying a scan selection screen (not illustrated) from the MFP 101. The scan selection screen displays selections of a transmission method, such as electronic mail transmission (an E-mail), file transmission by SMB or FTP, and Internet fax (I-fax) transmission. Touching the displayed selection display screen by the user causes each transmission setting screen to be displayed.

An address book 304 is a key for displaying an address book screen of the MFP 101.

The LED 310 and the LED 311 are provided to notify the user of the state of the MFP 101. The LED 310 lights up while the electronic mail or the print job is being received or executed, and the LED 311 lights up when some error has occurred in the MFP 101,

A STOP 306 is a key for canceling various kinds of operations. In the present exemplary embodiment, the STOP 306 is a resident key constantly displayed on the operation unit 116,

A HOME 307 is a key for displaying the HOME screen 308. In the present exemplary embodiment, the HOME 307 is a resident key constantly displayed on the operation unit 116.

A menu 312 is a key for displaying a screen for configuring an environmental setting such as an employed language and a setting of each of the functions.

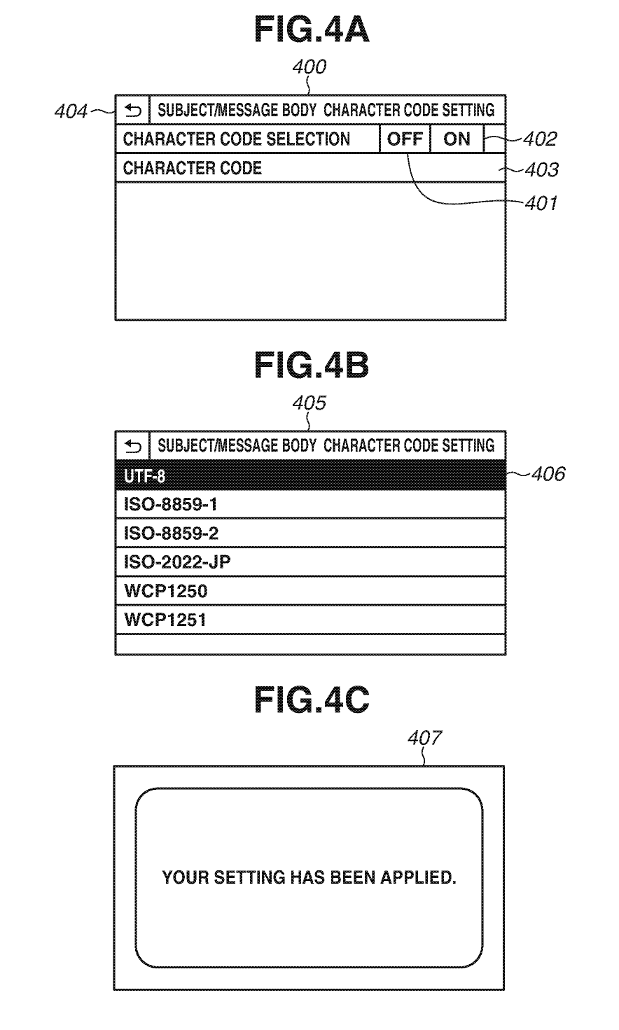

FIGS. 4A to 4C illustrate screens for setting a character code for use in a conversion of a character code of a character written in a subject/message body of the electronic mail (hereinafter referred to as character code setting screens) according to the present exemplary embodiment. FIGS. 4A to 4C illustrate the character code setting screens, omitting displays of the resident keys such as the STOP 306 and the HOME 307.

A character code setting screen 400 illustrated in FIG. 4A is one example of a screen to which the MFP 101 can transition from the menu 312 on the HOME screen 308. OFF/ON of a character code selection function can be set by touching any of an OFF key 401 and an ON key 402.

Further, in a case where the character code selection function is set to ON, a character code key 403 becomes selectable by the user. If the user selects the character code key 403, the MFP 101 transitions to a character code selection screen 405 illustrated in FIG. 4B. If the user selects a return key 404, the MFP 101 can return to the screen before the transition.

On the character code selection screen 405 illustrated in FIG. 4B, the user can select the character code for use in the conversion of the character code of the subject/message body. The character code selected by the user is highlighted as indicated by a row 406, and the CPU 111 sets the character code. Then, a setting completion screen 407 illustrated in FIG. 4C is displayed on the operation unit 116. Further, the storage 114 or the RAM 113 stores the setting of the character code therein.

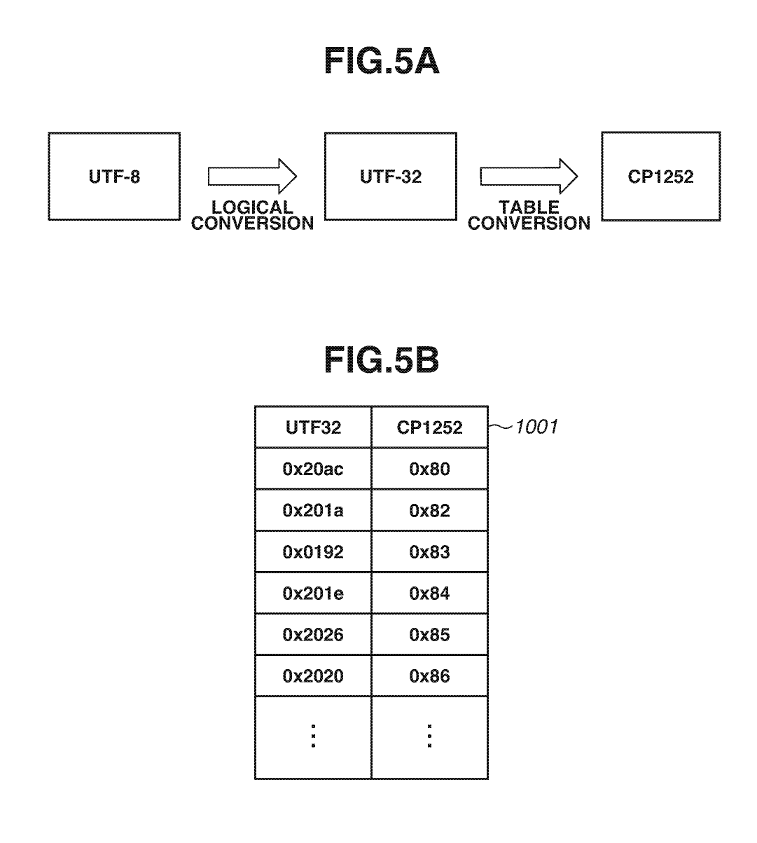

FIGS. 5A and 5B illustrate one example of character code conversion processing when the electronic mail is transmitted, and a character code conversion list, respectively,

FIG. 5A illustrates one example of the character code conversion processing when the electronic mail is transmitted. In this example, the conversion processing is performed to convert the character code from the Unicode Transformation Format (UTF)-8 character code into the Code Page (CP) 1252 character code as an example in a case where the user selects CP 1252 in FIG. 4B.

FIG. 5B illustrates one example of the character code conversion table. In this example, FIG. 5B illustrates a conversion table between UTF-32 and CP 1252.

UTF-8 is a character code acquired by serializing UTF-32. Therefore, in FIG. 5A, the CPU 111 logically converts UTF-8 into UTF-32.

After the logical conversion ends, the CPU 111 converts the character code from UTF-32 into CP 1252 with use of the character conversion table illustrated in FIG. 5B. For example, a character corresponding to a character code “0x20ac” in UTF-32 is converted into “0x80” in CP 1252. In other words, in the character code conversion processing, the character code is converted with use of a character code table in which a character code before the conversion and a character code after the conversion correspond to each other. If the character code of the character before the conversion does not correspond to the character code of the character after the conversion at this time, a garbled character or the like is undesirably generated and the character code cannot be correctly converted.

A plurality of character conversion tables in which a predetermined character code before the conversion and a predetermined character code after the conversion correspond to each other, among a plurality of character codes supported by the image processing apparatus, is stored in the storage 114 in advance. Further, when the character code is set in FIG. 4B, font data associated with the character code is developed, by which a font of the character can be acquired.

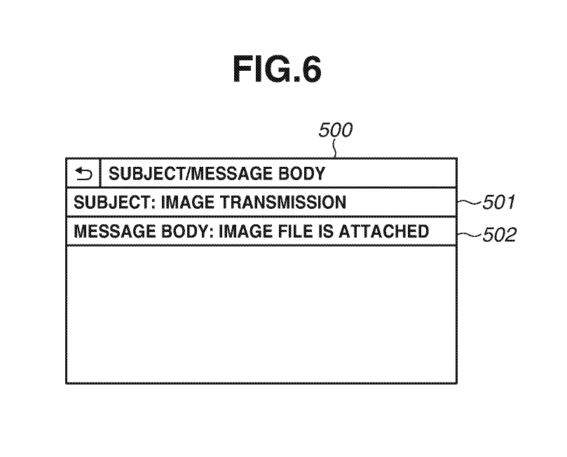

FIG. 6 illustrates a display screen on which a character input by the user is displayed in the subject/message body of the electronic mail. FIG. 6 illustrates the operation screen, omitting the displays of the resident keys such as the STOP 306 and the HOME 307 illustrated in FIG. 3.

A subject/message body screen 500 is one example of a screen to which the MFP 101 transitions by being prompted by a touch on the menu 312 illustrated in FIG. 3. When a subject 501 is touched, the MFP 101 transitions to a not-illustrated subject input screen, which allows the user to input the subject. When a message body 502 is touched, the MFP 101 transitions to a not-illustrated message body input screen, which allows the user to input the message body. An input character string is partially or entirely displayed in each of the subject 501 and the message body 502 of the subject/message body screen 500,

In FIG. 6, in a case where the subject/message body of the electronic mail is set via the web browser with use of the external information processing apparatus, a character code based on the browser is used as the character code of the character written in the subject/message body.

Accordingly, if the character code of the character whose input is received from the external information processing apparatus is converted into a character code preset in the MFP 101, the character code conversion processing may be unable to be correctly performed.

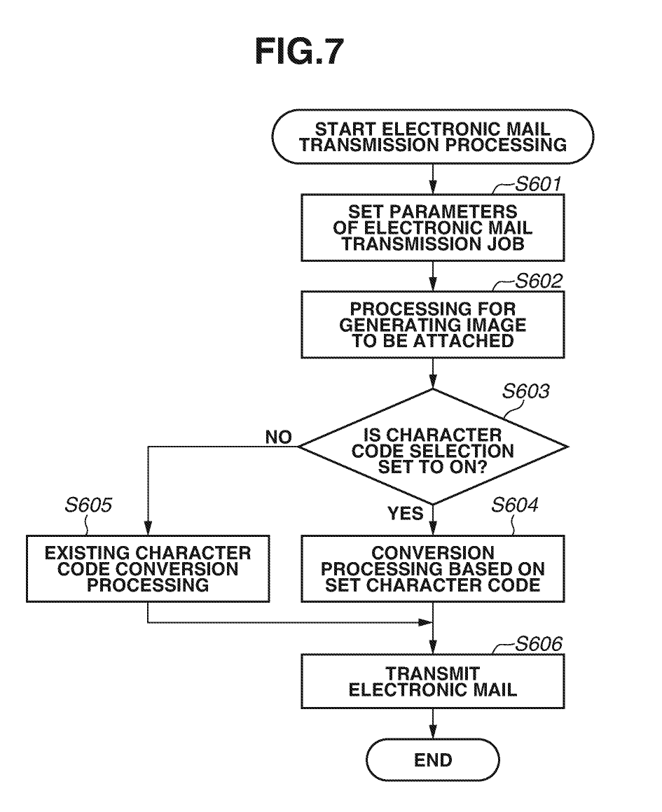

FIG. 7 is a flowchart regarding electronic mail transmission processing. For each operation (step) of the flowchart according to the present exemplary embodiment, the CPU 111 reads out a control program stored in the ROM 112 or the storage 114 into the RAM 113 and executes it. The CPU 111 starts the electronic mail transmission processing by being prompted by a touch on a mail transmission key.

In step S601, the CPU 111 sets parameters such as a transmission destination, a subject/message body, a format of an attached image, and a size of a read image. After step S601 ends, the processing proceeds to step S602.

In step S602, the reading unit 118 generates image data to be attached to the electronic mail by reading an original document (image generation processing). After step S602 ends, the processing proceeds to step S603.

in step S603, the CPU 111 determines whether the function of selecting the character code for use in the character code conversion processing is set to ON on the character code setting screen 400 illustrated in FIG. 4A. In a case where the character code selection function is set to ON (YES in step S603), the processing proceeds to step S604. In a case where the character code selection function is not set to ON (the character code selection function is set to OFF) (NO in step S603), the processing proceeds to step S605.

In step S604, the CPU 111 converts the character code of the character written in the subject/message body into the character code set in FIGS. 4A to 4C. More specifically, the CPU 111 recognizes the character code of the character written in the subject/message body. Then, the CPU 111 performs the character code conversion processing to convert the character code from the character code of the character written in the subject/message body (the recognized character code) into the character code set in FIGS. 4A to 4C with use of the character code table based on the character code set in FIGS. 4A to 4C. After step S604 ends, the processing proceeds to step S606.

In step S605, the CPU 111 performs existing character code conversion processing on the character code of the character written in the subject/message body. Now, the existing character code conversion processing will be described. For example, the CPU 111 recognizes the character code of the character written in the subject/message body. Then, the CPU 111 performs the character code conversion processing to convert the character code from the character code of the character written in the subject/message body (the recognized character code) into the character code preset in the apparatus with use of a character code table based on the character code preset in the apparatus. This is the existing character code conversion processing. Being preset in the apparatus refers to being built in the apparatus as a setting in advance and to being unable to be changed. After step S605 ends, the processing proceeds to step S606.

In step S606, the CPU 111 causes the character represented by the converted character code and the image data generated in step S602 to be transmitted as the electronic mail. After step S606 ends, the electronic mail transmission processing according to the present exemplary embodiment ends.

According to such a configuration, the image processing apparatus becomes able to transmit the electronic mail after correctly converting the character code of the character written in the electronic mail when transmitting the electronic mail containing the character whose input is received from the web browser of the external information processing apparatus. Then, the image processing apparatus becomes able to prevent or reduce the generation of the garbled character on the transmission destination.

The image processing apparatus has been described as being configured to cause the user to select the character code for use in the character code conversion processing before touching the transmission key, but can be configured to display the character code selection screen 405 in step S604 and use the character code selected by the user for the character code conversion processing. Further, in the present exemplary embodiment, the character processed by the character code conversion processing is assumed to be the character written in the subject/message body, but can include a header.

### (Exemplary Modification)

The present exemplary modification relates to character code conversion processing in a case where there is an inconvertible character when the character code conversion processing is performed, in terms of which the present exemplary modification is different from the present exemplary embodiment,

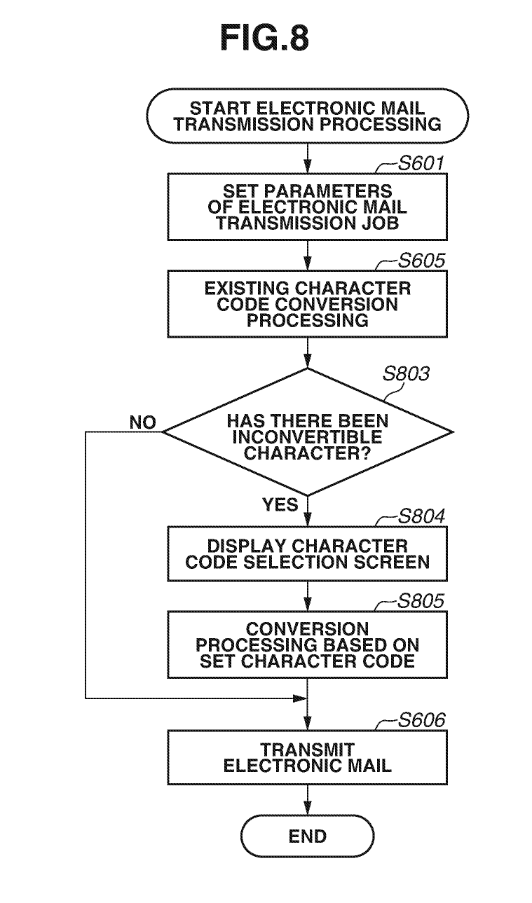

FIG. 8 is a flowchart regarding electronic mail transmission processing according to the exemplary modification. Similar steps to the flowchart illustrated in FIG. 7 according to the exemplary embodiment will be identified by the same step numbers, and detailed descriptions thereof will be omitted below,

In FIG. 8, after step S601 ends, the processing proceeds to step S605. Then, in step S605, the CPU 111 performs the existing character code conversion processing. After step S605 ends, the processing proceeds to step S803.

In step S803, the CPU 111 determines whether there has been a character unable to be converted by the existing character code conversion processing (an inconvertible character) in step S605. In a case where there has been an inconvertible character (YES in step S803), the processing proceeds to step S804. In a case where there has been no inconvertible character (NO in step S803), the processing proceeds to step S606. Now, the inconvertible character refers to, for example, a character represented by a character code unable to be correctly converted due to a lack of the character code corresponding to the character code of the character written in the subject/message body in the character code table like the example illustrated in FIG. 5B.

In step S804, the CPU 111 displays the character code selection screen 405, and sets the character code for use in the character code conversion processing to the character code selected by the user. After step S804 ends, the processing proceeds to step S805.

In step S805, the CPU 111 performs the character code conversion processing in such a manner that the character is represented by the character code set in step S804. After step S805 ends, the processing proceeds to step S606.

After step S606 ends, the processing regarding the electronic mail transmission processing according to the present exemplary modification ends.

The existing character code conversion processing is performed after step S601 in FIG. 8, but the character code conversion processing can be performed with use of the character code selected by the user, similarly to step S604 illustrated in FIG. 7.

Such a configuration also brings about advantageous effects similar to the present exemplary embodiment. Further, according to the present exemplary modification, in a case where the inconvertible character is generated in the character code conversion processing performed first, this character can be converted by the character code conversion processing performed next. Therefore, the image processing apparatus further becomes able to transmit the electronic mail after correctly converting the character code of the character written in the electronic mail.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™) a flash memory device, a memory card, and the like.

While various embodiments of the present disclosure have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-187133, filed Sep. 27, 2017, which is hereby incorporated by reference herein in its entirety.

What is claimed is:

1. An image processing apparatus including a transmission unit configured to transmit an electronic mail containing a character input from an external information processing apparatus via a web browser, the image processing apparatus comprising:
a reception unit configured to receive a character code; and
a conversion unit configured to convert a character code of the character contained in the electronic mail,
wherein the conversion unit converts the character code of the character input from the external information processing apparatus into the character code received by the reception unit, and
wherein the transmission unit transmits the electronic mail containing the character represented by the character code converted by the conversion unit.

2. The image processing apparatus according to claim 1, further comprising a transmission instruction reception unit configured to receive an instruction to transmit the electronic mail,
wherein the reception unit receives the character code before the transmission instruction reception unit receives the instruction to transmit the electronic mail.

3. The image processing apparatus according to claim 1, further comprising a transmission reception unit configured to receive an instruction to transmit the electronic mail,
wherein the reception unit receives the character code after the transmission reception unit receives the instruction to transmit the electronic mail and before the conversion unit converts the character code of the character contained in the electronic mail.

4. The image processing apparatus according to claim 1, further comprising a reading unit configured to read an original document to generate image data of the original document,
wherein the transmission unit transmits the electronic mail to which the image data generated by the reading unit is attached.

5. The image processing apparatus according to claim 1, further comprising a different conversion unit configured to convert the character code of the character contained in the electronic mail before the conversion unit converts the character code of the character contained in the electronic mail,
wherein the different conversion unit converts the character code before the conversion unit converts the character code, and the conversion unit converts the character code in a case where there is an inconvertible character when the different conversion unit converts the character code.

6. The image processing apparatus according to claim 1, further comprising an acquisition unit configured to develop the character code received by the reception unit to acquire a character code table,
wherein the conversion unit converts the character code of the character contained in the electronic mail into the character code received by the reception unit with use of the character code table.

7. A method for controlling an image processing apparatus including transmitting an electronic mail containing a character input from an external information processing apparatus via a web browser, the method comprising:
receiving a character code; and
converting a character code of the character contained in the electronic mail, wherein the converting includes converting the character code of the character input from the external information processing apparatus into the character code received by the receiving, and
wherein the transmitting includes transmitting the electronic mail containing the character represented by the character code converted by the converting.

8. The method for controlling the image processing apparatus according to claim 7, further comprising receiving an instruction to transmit the electronic mail,
wherein the character code is received by the receiving the character code before the receiving the instruction to transmit the electronic mail.

9. The method for controlling the image processing apparatus according to claim 7, further comprising receiving an instruction to transmit the electronic mail,
wherein the character code is received by the receiving the character code after the instruction to transmit the electronic mail is received by the receiving the instruction to transmit the electronic mail and before the character code of the character contained in the electronic mail is converted by the converting.

10. The method for controlling the image processing apparatus according to claim 7, further comprising reading an original document to generate image data of the original document,
wherein the transmitting includes transmitting the electronic mail to which the image data generated by the reading is attached.

11. The method for controlling the image processing apparatus according to claim 7, further comprising converting, as different converting, the character code of the character contained in the electronic mail before the character code of the character contained in the electronic mail is converted by the converting,
wherein the character code is converted by the different converting before the character code is converted by the converting, and the character code is converted by the converting in a case where there is an inconvertible character when the character code is converted by the different converting.

12. The method for controlling the image processing apparatus according to claim 7, further comprising developing the character code received by the receiving to acquire a character code table,
wherein the converting includes converting the character code of the character contained in the electronic mail into the character code received by the receiving with use of the character code table.

13. The method for controlling the image processing apparatus according to claim 8, further comprising setting whether to permit the character code to be received by the receiving.

14. A storage medium storing a program for causing a computer to perform a method for controlling an image processing apparatus including transmitting an electronic mail containing a character input from an external information processing apparatus via a web browser, the method comprising:
receiving a character code; and
converting a character code of the character contained in the electronic mail,
wherein the converting includes converting the character code of the character input from the external information processing apparatus into the character code received by the receiving, and
wherein the transmitting includes transmitting the electronic mail containing the character represented by the character code converted by the converting.
